(19) United States
(12) Patent Application Publication
(10) Pub. No.: US 2018/0303065 A1
(43) Pub. Date: Oct. 25, 2018

(54) DEFECATION TRAINING DEVICE AND METHOD FOR COMPANION ANIMAL

(71) Applicant: Chang Sub LEE, Gumi-si, Gyeongsangbuk-do (KR)

(72) Inventor: Chang Sub LEE, Gumi-si, Gyeongsangbuk-do (KR)

(21) Appl. No.: 15/764,652

(22) PCT Filed: Nov. 23, 2016
(86) PCT No.: PCT/KR2016/013538

§ 371 Date: Mar. 29, 2018

(30) Foreign Application Priority Data
Jul. 22, 2016 (KR) 10-2016-0093502
Sep. 5, 2016 (KR) 10-2016-0114111

(51) Int. Cl. A01K 15/02; A01K 1/015; A01K 5/02; A01K 1/01

(52) U.S. Cl. CPC A01K 15/021; A01K 1/01; A01K 5/02; A01K 1/0157

(57) ABSTRACT

Provided are an apparatus for training a companion animal for defecation and a method thereof. The apparatus includes a pad storage unit configured to store a defecation pad; a pad treating unit configured to treat the defecation pad by rolling up the defecation pad when the companion animal defecates on the defecation pad provided on a defecation table; an image processing unit configured to photograph the defecation pad and process a photographed image; and a control unit configured to analyze the image processed by the image processing unit to determine whether the defecation pad is used for defecation, wherein the control unit controls an operation of the pad treating unit to treat the used defecation pad and provide a new defecation pad on the defecation table when it is determined that the defecation pad is used for defecation.

### TECHNICAL FIELD

The present invention relates to an apparatus for training a companion animal for defecation and a method thereof, and more particularly, to an apparatus for training a companion animal for defecation, which are capable of automatically treating a defecation pad for a companion animal and training a companion animal to defecate at a predetermined place, and a method thereof.

### BACKGROUND ART

In recent years, the traditional family structure has changed due to the low fertility rate, the aging population, and the increase in the number of single-person households, and interest and demand for companion animals have been rapidly increased.

In particular, the concept of pet has been changed to the concept of companion animal which is a lifelong partner, and the Korean government is pursuing legislation to systematically nurture the pet animal industry as a new business in 2016.

Thus, currently, the domestic population with companion animals is more than 10 million, and the market size is more than 2 trillion won, increasing more than 20% every year.

Meanwhile, there is required to properly handle defecation while a companion animal is kept.

In particular, it is difficult to identify and handle the defecation pad used for defecation by a companion animal every time when the companion animal defecates.

Accordingly, there has been developed a technique for rapidly treating a defecation pad after defecation of a companion animal.

As examples, there have been disclosed techniques for automatically treating a defecation pad used for defecation by a companion animal in Korean Registered Patent No. 10-1610777 (issued on Apr. 8, 2016) and Korean Patent Publication No. 10-2005-0029643 (published on Mar. 28, 2005).

### DISCLOSURE

### Technical Problem

However, the defecation treating apparatus according to the related art treats the defecation pad after a user directly confirms whether defecation is performed or after it is checked whether the defecation is performed by installing a sensor such as a weight sensor or a moisture sensor after the companion animal defecates.

Thus, the defecation treating apparatus according to the related art has inconvenience because the user is to directly check whether the defecation is performed at any time and cannot accurately determine whether defecation is performed when the detection sensor is used.

In addition, since the defecation treating apparatus according to the related art is applied for the defecation trained companion animal, the object of use is limited.

Therefore, there is required to develop a technique capable of accurately check whether the companion animal defecates, automatically treating the defecation pad when defecation is confirmed, and training the companion animal for defecation by giving a reward such as snack to the companion animal which defecates at a correct position.

To solve the problems of the related art, an object of the present invention is to provide an apparatus for training a companion animal for defecation, which is capable of automatically treat a defecation pad used for defecation by the companion animal and a method thereof.

Another object of the present invention is to provide an apparatus for training a companion animal for defecation, which is capable of forming a conditioned reflex using sound and giving a reward such as snack to the companion animal which defecates at a correct position, thereby encouraging the companion animal to be trained for defecation, and a method thereof.

Still another object of the present invention is to provide an apparatus for training a companion animal for defecation, which is capable of allowing a user to check the companion animal and the state of a defecation pad from an outside, controlling an operation, and performing a video or voice call, and a method thereof.

### Technical Solution

To achieve the objects, in accordance with an aspect of the present invention, there is provided an apparatus for training a companion animal for defecation, which includes a pad storage unit configured to store a defecation pad; a pad treating unit configured to treat the defecation pad by rolling up the defecation pad when the companion animal defecates on the defecation pad provided on a defecation table; an image processing unit configured to photograph the defecation pad and process a photographed image; and a control unit configured to analyze the image processed by the image processing unit to determine whether the defecation pad is used for defecation, wherein the control unit controls an operation of the pad treating unit to treat the used defecation pad and provide a new defecation pad on the defecation table when it is determined that the defecation pad is used for defecation.

In addition, to achieve the objects, in accordance with an aspect of the present invention, there is provided a method of training a companion animal for defecation, which includes (a) photographing whether the companion animal moves to a preset position on a defecation table and a defecation state by using an image processing unit; (b) determining, by a control unit, whether the companion animal defecates by processing an image photographed in step (a); and (c) treating a used defecation pad and providing a new defecation pad by using a pad treating unit when it is determined in step (b) that the companion animal defecates.

### Advantageous Effects

As described above, according to the apparatus and method for training a companion animal for defecation according to the present invention, the image obtained by photographing the defecation pad may be analyzed to accurately determine whether the companion animal defecates and the companion pad may be automatically treated when the defecation is confirmed.

In addition, according to the present invention, the companion animal may be encouraged to be trained for defecation by giving a reward such as snack to companion animal which defecates at a correct position.

In addition, according to the present invention, when the companion animal moves onto the defecation table, the previously stored sound may be output to train the companion animal for defecation by using conditioned reflex.

In addition, according to the present invention, a user may check the state of the companion animal and whether defecation is performed from an outside. The defecation pad may be treated according to the checking result and give a reward such as snack to the companion animal or the interest and praise of the user may be transferred through a video or voice call, so that the companion animal is trained for defecation and the training effect is maximized, thereby effectively keeping the companion animal.

### DESCRIPTION OF DRAWINGS

FIG. 1 is a block diagram illustrating an apparatus for training a companion animal for defecation according to a preferable embodiment of the present invention.

FIG. 2 is a front view of the apparatus for training a companion animal for defecation illustrated in FIG. 1.

FIG. 3 is a plan view of the apparatus for training a companion animal for defecation illustrated in FIG. 1.

FIG. 4 is a flowchart illustrating steps of a method of controlling an apparatus for training a companion animal for defecation according to a preferred embodiment of the present invention.

### BEST MODE

### Mode for Invention

Hereinafter, an apparatus for training a companion animal for defecation and a method thereof according to a preferable embodiment of the present invention will be described in detail with reference to accompanying drawings.

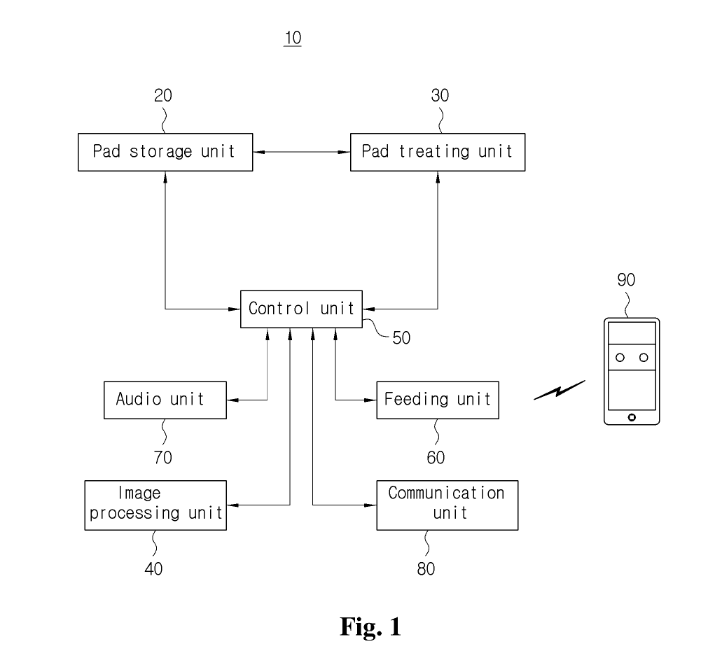

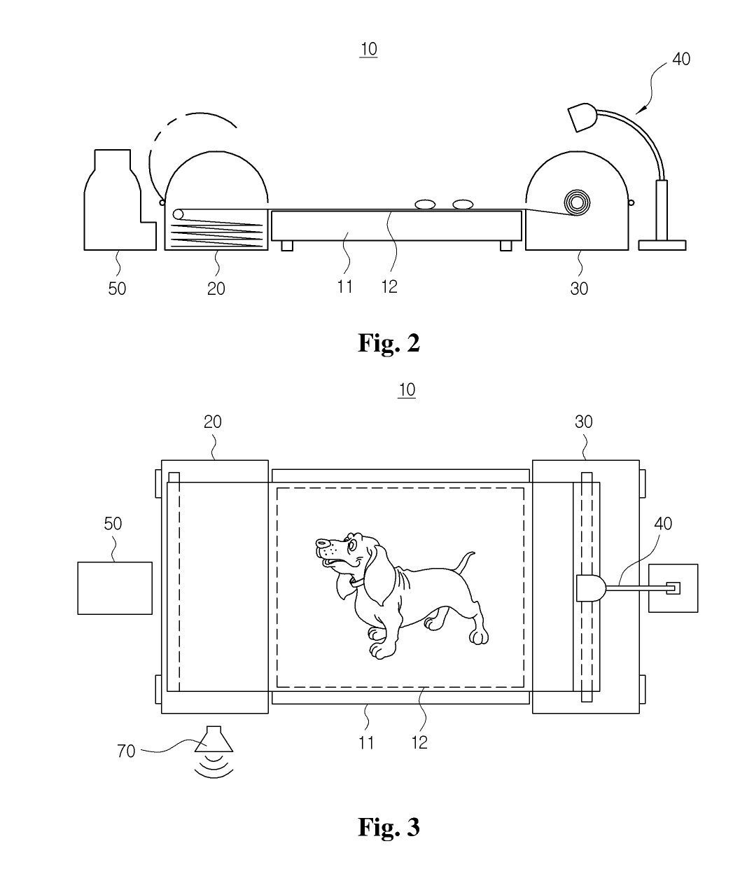

FIG. 1 is a block diagram illustrating an apparatus for training a companion animal for defecation according to a preferable embodiment of the present invention. FIG. 2 is a front view of the apparatus for training a companion animal for defecation illustrated in FIG. 1. FIG. 3 is a plan view of the apparatus for training a companion animal for defecation illustrated in FIG. 1.

As shown in FIGS. 1 to 3, an apparatus 10 for training a companion animal for defecation according to a preferable embodiment of the present invention may include a pad storage unit 20 configured to store a defecation pad 12, a pad treating unit 30 configured to treat the defecation pad by rolling up the defecation pad 12 when the companion animal defecates on the defecation pad 12 provided on a defecation table 11, an image processing unit 40 configured to photograph the defecation pad 12 and process a photographed image, and a control unit 50 configured to analyze the processed image to determine whether the defecation pad 12 is used for defecation, where the control unit 50 controls an operation of the pad treating unit 30 to treat the used defecation pad 12 and provide a new defecation pad on the defecation table 11 when it is determined that the defecation pad 12 is used for defecation.

In addition, the apparatus 10 for training a companion animal for defecation according to a preferable embodiment of the present invention may further include a feeding unit 60 configured to discharge feed stored therein according to a control signal of the control unit 50, and an audio unit 70 configured to output a previously stored sound to provide the companion animal with an atmosphere for a conditioned reflex to allow the companion animal to smoothly defecate when the companion animal moves to a preset position on the defecation table for defecation.

In addition, the apparatus 10 for training a companion animal for defecation according to a preferable embodiment of the present invention may further include a communication unit 80 connected to Internet. The communication unit 80 transmits the image photographed by the image processing unit 40 to a portable terminal 90 of a user under control of the control unit 50 and transmits an operation command or a voice or video call signal received from the portable terminal 90 to the control unit 50.

Of course, the present invention may further provide an image display unit (not shown) configured to display an image to the image processing unit 40, and may be modified to allow a user to establish a voice or video call through the portable terminal 90 at an outside thereof by using the audio unit 70 and the video output unit such that the interest and praise of the user is transferred to the companion animal while the user confirms the defecation state of the companion animal.

The pad storage unit 20 may store the defecation pad 12 in a state that the defecation pad 12 is multi-folded or rolled in a form of a roll.

A body of the pad storage unit 20 may be provided with a door which is openable and closable to supplement a new defecation pad 12.

The defecation table 11 is disposed at a position designated for defecation by the companion animal and the defecation pad 12 is continuously provided to the upper portion of the defecation table 11.

The pad treating unit 30 may be installed at one side of the defecation table 11 and may remove the defecation and the odor generated from the defecation by treating the used defecation pad 12 in the roll form.

The pad treating unit 30 may include a package module (not shown) configured to package the defecation pad 12 rolled in the roll form, such that the defecation is prevented from falling down from the inside of the pad treating unit 30 or the odor of the defecation is prevented from leaking to the outside.

In addition, a door may be installed to an upper portion or a side surface of the pad treating unit 30 to be openable and closable such that the defecation pad 12 rolled in the roll form is removed.

The image processing unit 40 may include a camera configured to photograph the defecation pad 12 and a processing module configured to process the image photographed by the camera in order to check whether the companion animal defecates.

The camera may be installed around the defecation table 11 to photograph the defecation table 12 accurately.

In addition, the camera may include a web camera capable of performing pan, tilt and zoom operations to confirm the state of the companion animal or the operation state of the defecation training apparatus 10.

The processing module detects the color from the photographed image and calculates a discoloration region due to defecation, that is, the area of the discoloration region.

The processing module may check whether the companion animal moves to the preset position and transfer the check result to the control unit 50.

Thus, as the check result of the processing module, when it is checked that the companion animal moves to the preset position, the control unit 50 may control the operation of the audio unit 70 such that the sound stored in advance is output to allow the companion animal to smoothly defecate.

As described above, according to the present invention, when the companion animal moves onto the defecation table, the previously stored sound may be output to train the companion animal for defecation by using conditioned reflex.

In this case, the output sound may be set in various sounds such as music or voice of a user.

In addition, the control unit 50 checks whether the area of the discoloration region calculated by the image processing unit 40 exceeds a preset area and determines that the area is in the defecation state when it is checked that the area of the discoloration region exceeds the preset area as the check result.

Thus, when it is determined that the defecation pad 12 is used for defecation, the control unit 50 generates a control signal for controlling the operation of the pad treating unit 30 such that the used defecation pad 12 is treated and a new defecation pad is supplied.

The feeding unit 60 may include a storage container configured to store feed or a snack desired to be provided to the companion animal, and a transfer module configured to transfer the stored feed or snack to a feeding table.

Although the feeding unit 60 may be provided separately from the apparatus 10 for training a companion animal for defecation, the feeding unit 60 may be provided integrally with the apparatus 10 for training a companion animal for defecation and operated according to the control signal of the control unit 50 in order to obtain the effect of training a companion animal for defecation.

The audio unit 70 may include a storage unit configured to store sound such as specific music or voice of a user, and a speaker configured to output the stored sound according to the control signal of the control unit.

The image display unit may include a display module configured to display the received video call signal on a screen.

The communication unit 80 may be connected to a network device provided in a house or a building in a wired or wireless communication scheme to communication with the portable terminal 90 of the user through Internet.

To this end, the portable terminal 90 of the user may be connected to the apparatus 10 for training a companion animal for defecation to receive and display the photographed image. A dedicated application, which receives the user's operation command and operates the apparatus 10 for training a companion animal for defecation to perform a voice or video call, may be installed to the portable terminal 90.

The portable terminal may be prepared with various terminal devices having a communication function such as a smart phone, a tablet PC, a laptop computer, a desktop computer, or the like such that the dedicated application is executed to perform the input of an operation command together with the voice or video call function. Thus, when the operation command is received from the user through the communication unit 80, the control unit 50 may control the operation of the pad treating unit 30 to treat the defecation pad 12 or control the operation of the feeding unit 60 to provide feed or snack to the companion animal according to the received operation command.

In addition, when a voice or video call is established between the control unit 50 and the portable terminal 90 of the user through the communication unit 80, the control unit 50 may control the operation of the audio unit 70 or the image output unit such that the voice or video signal received from the portable terminal 80 is output.

In addition, the control unit 50 may control the pan, tilt, and zoom operations of the camera provided in the image processing unit 40 according to the operation command.

As described above, according to the present invention, the state of the defecation pad may be photographed as an image, the photographed image may be analyzed to accurately determine whether the defecation is performed and may promptly treats the defecation pad when it is determined that the defecation is performed.

In addition, according to the present invention, when the companion animal moves onto the defecation table for defecation, the previously stored sound may be output to train the companion animal for defecation by using conditioned reflex.

In addition, according to the present invention, when it is confirmed that a companion animal correctly defecates on the defecation pad, the companion animal is rewarded by providing feed or snack or interest and praise of the user to companion animal through a voice or video call, so that the companion animal is encouraged to be trained for defecation and the defecation training effect is maximized.

In addition, by providing the image photographed by the image processing unit to the portable terminal of the user, the user may check the defecation state from the outside and control the operation of the defecation training apparatus, thereby further improving the convenience.

Meanwhile, although the present embodiment has been described in which it is checked whether the companion animal moves to the preset position on the defecation table by using the image processing unit, the present invention is not limited thereto.

That is, the present invention may be modified by installing a weight detecting sensor for detecting weight on a lower portion of the defecation table, or a sensor, such as an ultrasonic sensor or an infrared sensor, for detecting the approach of the companion animal on one side of the image processing unit to detect whether the companion animal moves to the defecation pad.

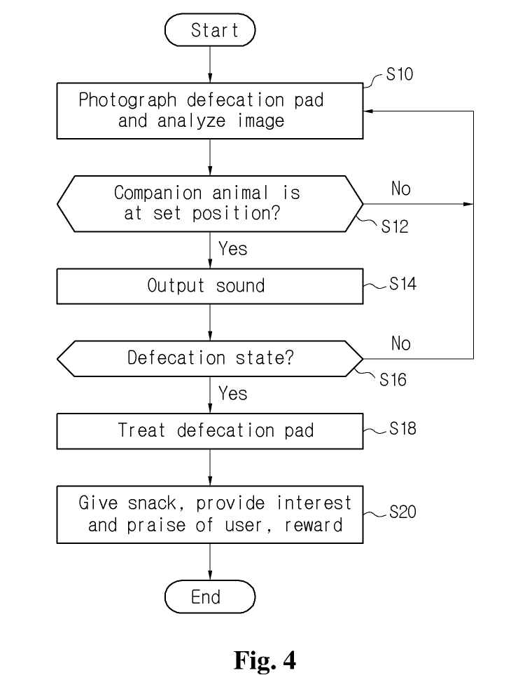

Hereinafter, a method of controlling an apparatus for training a companion animal for defecation according to a preferred embodiment of the present invention will be described with reference to FIG. 4.

FIG. 4 is a flowchart illustrating steps of a method of controlling an apparatus for training a companion animal for defecation according to a preferred embodiment of the present invention.

When power is supplied to the defecation training apparatus 10, the control unit 50 initializes each unit and controls to prepare an operation for checking the defecation state of the defecation pad 12 and treating the defecation pad 12.

In step S10, the image processing unit 40 photographs the defecation pad 12, processes the photographed image, and transmits the processed image information to the control unit 50.

In this case, the image information may include approach information obtained by sensing the companion animal that approaches the preset position on the defecation pad 11 and area information of the discoloration region.

In step S12, the control unit 50 checks whether the companion animal has moved to the preset position by using the approach information of the received image information.

When it is determined in step S12 that the companion animal does not move to the preset position, the controller 50 controls to repeat steps S10 and S12.

To the contrary, when it is determined in step S12 that the companion animal moves to the preset position, in step S14, the controller 50 controls the operation of the audio unit 60 such that sound such as music or user's voice stored in advance is output.

In this case, the control unit 50 may establish a voice or video call between the communication unit 80 and the portable terminal 90 of the user and may control the operation of the audio unit or the video output unit such that the voice or video call signal received from the portable terminal 90 is output.

Thus, the companion animal may listen to the sound output from the audio unit 60 or receive the user's interest and praise displayed on the image output unit, so that the companion animal may smoothly defecate by conditioned reflex.

In step S16, the control unit 50 compares the area of the discoloration region with the set area set in advance based on the received image information to check whether it is in the defecation state.

When it is determined in step S16 that the area of the discoloration region is equal to or smaller than the set area, the control unit 50 determines that the defecation is incomplete and goes to step S10.

To the contrary, when it is determined in step S16 that the area of the discoloration region exceeds the set area, the control unit 50 determines that it is in the defecation state.

Thus, in step S18, the control unit 50 controls the operation of the pad treating unit 30 to allow the used defecation pad 12 to be rolled.

Then, in step S20, the control unit 50 controls the operation of the feeding unit 60 to provide feed or snack stored therein to reward the companion animal which defecate at a correct position.

In this case, the control unit 50 may control the operation of the audio unit 60 or the image output unit such that the voice or video call signal received from the portable terminal 90 receives is output, thereby transferring the interest and praise of the user to the companion animal.

Thus, the companion animal may receive snack or feed or interest and praise of the user through a voice or video call after defecation, so that the companion animal is naturally trained for defecation.

Meanwhile, the control unit 50 may transmit the image photographed by the image processing unit 40 to the portable terminal 90 of the user while being connected to the portable terminal 90 of the user through the communication unit 80, and may control the operation of each unit according to the operation command received from the portable terminal 90 of the user.

According to the present invention, it may be accurately determined whether defecation is performed by using the image obtained by photographing the defecation pad and the used defecation pad may be promptly treated when it is determined that defecation is performed.

Although an exemplary embodiment of the present invention has been described for illustrative purposes, those skilled in the art will appreciate that various modifications, additions and substitutions are possible, without departing from the scope and spirit of the invention as disclosed in the accompanying claims.

Although the checking of whether the companion animal moves to the preset position on the defecation table by using the image processing unit has been described in the embodiment, the present invention is not necessarily limited thereto.

That is, the present invention may be modified by installing a weight detecting sensor for detecting weight on a lower portion of the defecation table, or a sensor, such as an ultrasonic sensor or an infrared sensor, for detecting the approach of the companion animal on one side of the image processing unit to detect whether the companion animal moves to the defecation pad.

In addition, although the example in which snack or feed is rewarded only when the defecation is performed at the correct position after the defecation state is checked has been described in the above-described embodiment, the present invention may be modified to include snack or feed immediately after the companion animal moves to the defecation table and defecates.

### INDUSTRIAL APPLICABILITY

The present invention may be applied to a technique of accurately determining whether defecation is performed by using the image obtained by photographing the defecation pad, rapidly treating the used defecation pad when it is determined that the defecation is performed, providing feed or snack to the companion animal which defecates at the correct position or transferring interest or praise of the user through a voice or video call for rewarding the companion animal to encourage the defecation training, and maximizing the effect of the defecation training.

1. An apparatus for training a companion animal for defecation, the apparatus comprising:
a pad storage unit configured to store a defecation pad;
a pad treating unit configured to treat the defecation pad by rolling up the defecation pad when the companion animal defecates on the defecation pad provided on a defecation table;
an image processing unit configured to photograph the defecation pad and process a photographed image; and
a control unit configured to analyze the image processed by the image processing unit to determine whether the defecation pad is used for defecation, wherein the control unit controls an operation of the pad treating unit to treat the used defecation pad and provide a new defecation pad on the defecation table when it is determined that the defecation pad is used for defecation.

2. The apparatus of claim 1, further comprising:
a feeding unit configured to discharge feed stored therein; and
an audio unit configured to output a previously stored sound to provide the companion animal with an atmosphere for a conditioned reflex to allow the companion animal to smoothly defecate when the companion animal moves to a preset position on the defecation table for defecation, thereby training the companion animal for defecation.

3. The apparatus of claim 2, further comprising:
a communication unit connected to Internet and configured to transmit the image photographed by the image processing unit to a portable terminal of a user under control of the control unit and to transmit an operation command, or a voice or video call signal received from the portable terminal to the control unit; and
an image output unit configured to display the video call signal received from the portable terminal on a screen,
wherein the control unit controls an operation of each unit according to the operation command received from the portable terminal and controls operations of the audio unit and the image output unit to output the received voice or video call signal.

4. The apparatus of claim 2, wherein the pad storage unit stores the defecation pad in a state that the defecation pad is multi-folded or in a state that the defecation pad is rolled in a form of a roll, and continuously supplies the defecation pad to an upper portion of the defecation table, and
the pad treating unit treats the used defecation pad by rolling up the defecation pad and includes
a package module configured to package the rolled defecation pad.

5. The apparatus of claim 2, wherein the image processing unit includes a camera configured to photograph the defecation pad, and
a processing module configured to process an image photographed by the camera,
wherein the processing module transmits image information to the control unit, in which the image information includes approach information obtained according to a result of checking whether the companion animal moves to the preset position, and area information of a discoloration region obtained by detecting a color from the photographed image and calculating an area of the discoloration region where a color is changed due to defecation.

6. The apparatus of claim 2, wherein the feeding unit includes a storage container configured to store feed or a snack for the companion animal; and
a transfer module configured to transfer the stored feed or snack to a feeding table, and
wherein the control unit controls an operation of the feeding unit to provide the feed or snack to the companion animal after the companion animal defecates at the preset position or after confirming a location of defecation.

7. A method of training a companion animal for defecation, the method comprising:
(a) photographing whether the companion animal moves to a preset position on a defecation table and a defecation state by using an image processing unit;
(b) determining, by a control unit, whether the companion animal defecates by processing an image photographed in step (a); and
(c) treating a used defecation pad and providing a new defecation pad by using a pad treating unit when it is determined in step (b) that the companion animal defecates.

8. The method of claim 7, wherein step (b) includes:
(b1) checking whether the companion animal moves to the preset position by using image information received from the image processing unit;
(b2) outputting a previously stored sound to provide the companion animal with an atmosphere for a conditioned reflex by using an audio unit to allow the companion animal to smoothly defecate when it is determined in step (b1) that the companion animal moves to the preset position; and
(b3) comparing an area of a discoloration region where a color is changed due to defecation with a preset area by using the image information received from the image processing unit to determine the defecation state.

9. The method of claim 8, wherein step (c) includes:
(c1) treating the defecation pad by rolling up the defecation pad and providing the new defecation pad by using the pad treating unit when it is determined that the defecation pad is in the defecation state; and
(c2) packaging the defecation pad, which is treated in a form of a roll, by using a package module provided in the pad treating unit.

10. The method of claim 7, further comprising:
(d) providing feed or a snack to the companion animal by using a feeding unit after the companion animal defecates at the preset position or after a location of defecation is confirmed.

11. The method of claim 10, further comprising:
(e) transmitting the image photographed by the image processing unit to a portable terminal of a user by using a communication unit and receiving an operation command or a voice or video call signal received from the portable terminal,
wherein the control unit controls an operation of each unit according to the received operation command, and
the audio unit or the image output unit outputs the received voice or video call signal to give interest of the user to the companion animal and to praise the companion animal.

12. The method of claim 8, further comprising:
(d) providing feed or a snack to the companion animal by using a feeding unit after the companion animal defecates at the preset position or after a location of defecation is confirmed.

13. The method of claim 9, further comprising:
(d) providing feed or a snack to the companion animal by using a feeding unit after the companion animal defecates at the preset position or after a location of defecation is confirmed.
